(19) United States
(12) Patent Application Publication
(10) Pub. No.: US 2005/0109714 A1
(43) Pub. Date: May 26, 2005

(54) Flock separator and flock separation method using same

(76) Inventor: Chenhsing Liu, Taipei (TW)

Correspondence Address: LAW OFFICES OF DAVID PAI, 1001 FOURTH AVENUE, SUITE 3200, SEATTLE, WA, 98154, US

(21) Appl. No.: 10/720,289

(22) Filed: Nov. 24, 2003

(51) Int. Cl. B04B 1/10; C02F 1/38

(52) U.S. Cl. 210/787; 210/804; 210/360.1; 494/56

(57) ABSTRACT

A flock separator is disclosed and claimed, which includes a container adapted to produce a centrifugal force to separate flocks from solution, lead-out tubes equiangularly and fixedly fastened to the container and adapted to guide flock-free solution out of the container, each lead-out tube having a first opening suspended in the fluid chamber near the central axis of the container and a second opening extended to the outside of the container, a first annular collector extended around the periphery of the container and adapted to collect output flocks from the drain port of the container, and a second annular collector extended around the periphery of the container and adapted to receive flock-free solution from the second opening of each lead-out tube.

### BACKGROUND OF THE INVENTION

1. Field of the Invention

The present invention relates to a flock separation method, which separates flocks from solution by means of a centrifugal force and the mass difference between flocks and solution. The invention relates also to a flock separator for use in the method.

2. Description of the Related Art

Various methods of separating impurities from solution are known. These methods are outlined hereinafter:

1. Gravity separation: This method is commonly used in water works, water treatment plants, and chemical plants to separate solid matter from water by means of sedimentation. This gravity separation method takes much time to separate solid matter from water. Further, the facility for this method is huge and expensive.

2. Centrifugal separation: This separation method is commonly used in laboratories for the separation of serum from blood for the advantage of high separation rate. However, this separation method is not suitable for continuous separation or big volume separation.

3. Diaphragm separation: This method is effective, but not suitable for high volume separation. Further, a pressure difference is required during separation, and reverse washing is necessary after a long use of the equipment. This method is not suitable for continuous separation.

4. Pressure filtration separation: This method uses sands, resins, and fibers to form a filter bed to separate solid matter from fluid. During operation, a pressure difference is required. For re-use, reverse washing is necessary. Further, this method is not suitable for continuous separation.

5. Evaporation or electrolysis separation: This method consumes a big amount of energy, not in conformity with environmental protection.

6. Screen separation: This method is not suitable for separating gelatinous fluid. Further, the meshes of the screen tend to be blocked, and the cleaning of the screen is not easy.

7. Material absorption: This method uses silica or carbon powder to absorb impurities. Because of its high cost but low efficiency, this method is not practical.

### BRIEF SUMMARY OF THE INVENTION

The present invention has been accomplished under the circumstances in view. It is one object of the present invention to provide a flock separation method, which separates flocks from solution by means of a centrifugal force and the mass difference between flocks and solution.

According to one aspect of the present invention, the flock separation method comprises the steps of: (a) preparing a container and then guiding a flock-containing solution into the container; (b) rotating the container to produce a centrifugal force and to further cause dense flocks to be separated from the solution and gathered at the border area around the periphery of the container and light flocks to be deposited on a bottom side inside the container to form a sedimentary deposit layer; (c) enabling the sedimentary deposit layer to catch flocks from the solution passing toward the central axis of the container and excess amount of deposited flocks to float from the sedimentary deposit layer toward the periphery of the container subject to the effect of the centrifugal force; and (d) guiding the accumulated flocks from the border area around the periphery of the container to the outside of the container and the flock-free solution from the center area of the container to the outside of the container. According to another aspect of the present invention, the flock separator comprises a container adapted to produce a centrifugal force, the container comprising a fluid chamber adapted to hold a flock-containing solution for separation, a drain port formed in the periphery thereof for outputting the separated flocks from the solution; at least one lead-out tube fixedly fastened to the container and inserted into the fluid chamber and adapted to guide flock-free solution out of the container, the at least one lead-out tube each having a first opening suspended in the fluid chamber near the central axis of the container and a second opening extended to the outside of the container; a first annular collector extended around the periphery of the container and adapted to collect output flocks from the drain port; and a second annular collector extended around the periphery of the container and adapted to receive flock-free solution from the second opening of each the at least one lead-out tube.

### BRIEF DESCRIPTION OF THE DRAWINGS

FIG. 1 is an elevational view of a flock separator according to the present invention.

FIG. 2 is a cutaway view of the flock separator according to the present invention.

FIG. 3 is a perspective view of a part of a drainage control unit for use with the flock separator according to the present invention.

### DETAILED DESCRIPTION OF THE PREFERRED EMBODIMENT

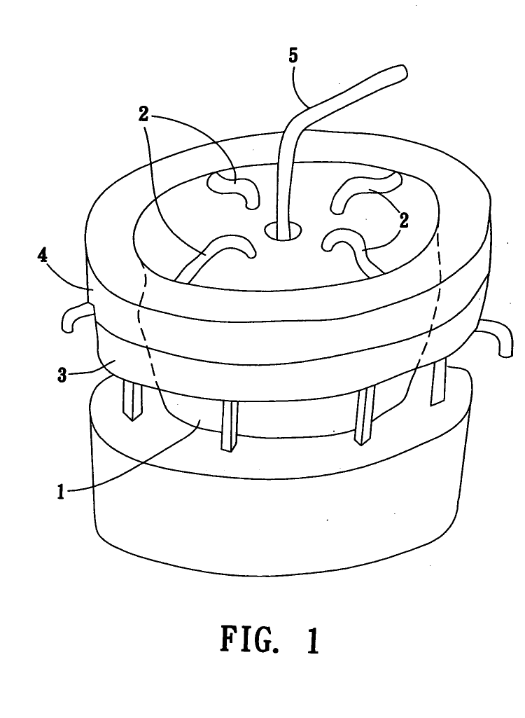

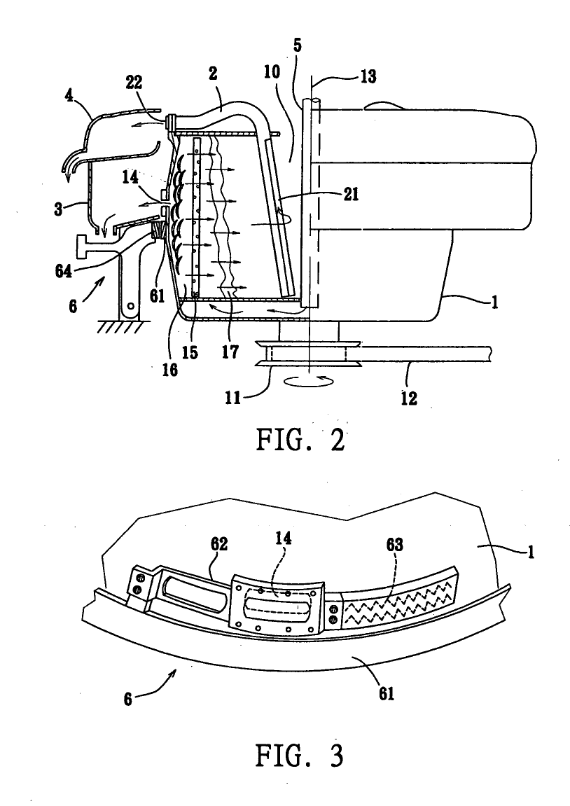

Referring to FIGS. 1 and 2, a flock separator for use to separate flocks from a solution in accordance with the present invention is shown comprising a container 1, at least one, for example, four lead-out tubes 2, a first annular collector 3 and a second annular collector 4.

The container 1 is shaped like a round barrel comprising a fluid chamber 10, a center shaft 13 vertically disposed at the center of the fluid chamber 10 and downwardly extended out of the bottom side of the container 1, a cylindrical strainer 15 mounted inside the fluid chamber 10 around the center shaft 13, a drain port 14 at the flank in fluid communication with the fluid chamber 10 and the outside of the container 1, and a drive provided at the bottom side outside the container 1. According to this embodiment, the drive comprises a belt wheel 11 fixedly fastened to the bottom end of the center shaft 13 outside the container 1, a belt 12 mounted on the belt wheel 11, and a motor (not shown) adapted to drive the belt 12 to rotate the belt wheel 11 and the center shaft 13.

The four lead-out tubes 2 are respectively equiangularly installed in the container 1 and inserted into the fluid chamber 10 for synchronous rotation with the container 1, each having a first opening 21 suspended in the fluid chamber 10 near the center shaft 13 and extended to the center shaft 13 and a second opening 22 extended away from and in a direction perpendicular to the center shaft 13.

The first annular collector 3 extends around the periphery of the container 1 corresponding to the elevation of the drain port 14 without direct contact with the periphery of the container 1. The side of the first annular collector 3 in proximity to the container 1 is an open side.

The second annular collector 4 extends around the periphery of the container 1 above the first annular collector 3 corresponding to the elevation of the second openings 22 of the lead-out tubes 2 without direct contact with the periphery of the container 1. The side of the second annular collector 4 in proximity to the container 1 is an open side.

The method of the present invention is to guide a flock-containing solution through a lead-in tube 5 into the fluid chamber 10 of the container 1 around the bottom side of the center shaft 13, and then to start the motor, causing the belt 12 to rotate the belt wheel 11 and the center shaft 13 at a high speed, and therefore the container 1 is rotated with the center shaft 13 to produce a centrifugal effect on the flock-containing solution. At the same time, flock-containing solution is continuously supplied to the fluid chamber 10 to squeeze existing flock-containing solution in the fluid chamber 10 toward the peripheral wall of the container 1, and therefore a mixing zone 16 is formed in the border area of the fluid chamber 10.

Due to density differential, denser flocks are gathered in the mixing zone 16 around the peripheral wall of the container 1, and the solution is moving toward the center shaft 13. Further, a small amount of lighter flocks will be carried with the solution toward the center shaft 13 and then deposited on the bottom wall of the container 1, forming a sedimentary deposit layer 17.

The sedimentary deposit layer 17 is formed of flocks entering the container 1 at an early stage but not expelled out of the container 1. The sedimentary deposit layer 17 works as filter means to catch light flocks or impurities from the solution passing toward the center shaft 13. When the amount of the sedimentary deposit layer 17 reaches a certain level, the centrifugal effect automatically forces excess amount of flocks to float away from the area around the center shaft 13 toward the peripheral wall of the container 1. The strainer 15 separates the mixing zone 16 from the sedimentary deposit layer 17, preventing the turbulent flow in the mixing zone 16 from interfering with the average density of the sedimentary deposit layer 17.

Finally, denser flocks are expelled out of the container 1 through the drain port 14 and collected by the first annular collector 3 and, at the same time, flock-free solution is guided out of the container 1 through the lead-out tubes 2 and received by the second annular collector 4. Thus, when flock-containing solution is continuously guided into the container 1 through the lead-in tube 5, the flock-solution separation process runs continuously.

Referring to FIG. 3, in order to control the drainage of flocks, a drainage control unit 6 is provided at the drain port 14. The drainage control unit 6 comprises a rotary friction ring 61 in friction contact with the periphery of the container 1 for synchronous rotation, a valve 62 adapted to close the drain port 14 upon rotary motion of the rotary friction ring 61 with the container 1, a spring member 63 adapted to return the valve 62 from the close position to the open position upon stoppage of the rotary motion of the rotary friction ring 61 and the container 1, and a brake 64. When the brake 64 is released, the valve 62 closes the drain port 14, and flocks are prevented from passing out of the container 1. When a certain amount of flocks in the container 1 is detected visually or by an instrument, the brake 64 is engaged to press the rotary friction ring 61 to lower the speed of rotation of the rotary friction ring 61. Due to a difference in speed between the rotary friction ring 61 and the container 1, the valve 62 is forced by the spring member 63 to open the drain port 14 for drainage of accumulated flocks. The extent to which the valve 62 (the drain port 14) is opened is dependent upon the amount of pressure imparted from the brake 64 to the rotary friction ring 61. When the brake 64 is released from the rotary friction ring 61, the spring member 63 pushes the valve 62 back to the close position to close the drain port 14.

Although a particular embodiment of the invention has been described in detail for purposes of illustration, various modifications and enhancements may be made without departing from the spirit and scope of the invention.

1. A flock separation method for separating flocks from a solution, comprising the steps of:
(a) preparing a container and then guiding a flock-containing solution into said container;
(b) rotating said container to produce a centrifugal force and to further cause dense flocks to be separated from the solution and gathered at the border area around the periphery of said container and light flocks to be deposited on a bottom side inside said container to form a sedimentary deposit layer;
(c) allowing said sedimentary deposit layer to catch flocks from the solution passing toward the central axis of said container and excess amount of deposited flocks to float from said sedimentary deposit layer toward the periphery of said container subject to the effect of said centrifugal force; and
(d) guiding accumulated flocks from the border area around the periphery of said container to the outside of said container and the flock-free solution from the center area of said container to the outside of said container.

2. A flock separator adapted to separate flocks from a solution, the flock separator comprising:
a container adapted to produce a centrifugal force, said container comprising a fluid chamber adapted to hold a flock-containing solution for separation, a drain port formed in the periphery of the container for outputting separated flocks from the solution;
at least one lead-out tube fixedly fastened to said container and inserted into said fluid chamber and adapted to guide flock-free solution out of said container, said at least one lead-out tube each having a first opening suspended in said fluid chamber near the central axis of said container and a second opening extended to the outside of said container;
a first annular collector extended around the periphery of said container and adapted to collect output flocks from said drain port; and
a second annular collector extended around the periphery of said container and adapted to receive flock-free solution from the second opening of each said at least one lead-out tube.

3. The flock separator as claimed in claim 2, further comprising a drainage control unit provided at said drain port and adapted to control output of flocks from said drain port, said drainage control unit comprising a rotary friction ring in friction contact with the periphery of said container for rotation with said container, a valve adapted to close or open said drain port to a certain extent dependent upon the speed of rotation of said rotary friction ring, a spring member, which supports said valve in the close position, and a brake adapted to impart a pressure to said rotary friction ring to lower the speed of rotation of said rotary friction ring.
